(19) United States
(12) Patent Application Publication
(10) Pub. No.: US 2018/0119837 A1
(43) Pub. Date: May 3, 2018

(54) TORQUE ALIGNMENT NUT AND INSTALLATION TOOL

(71) Applicant: FISHER CONTROLS INTERNATIONAL LLC, Marshalltown, IA (US)

(72) Inventor: Cale A. McKoon, Marshalltown, IA (US)

(21) Appl. No.: 15/337,886

(22) Filed: Oct. 28, 2016

(51) Int. Cl. F16K 27/02; F16K 1/12; F16K 1/32

(52) U.S. Cl. CPC F16K 27/02; F16K 1/32; F16K 1/12

(57) ABSTRACT

A fluid flow control device includes a valve body defining an inlet, an outlet, a throat disposed between the inlet and the outlet, and a bonnet opening, a control element having a valve plug and an elongated stem coupled to the valve plug, an extension bonnet coupled to the bonnet opening, a bellows disposed in the extension bonnet, and a bellows nut threaded onto the stem to secure the bellows in the extension bonnet and form a seal around the stem. The bellows nut includes a first surface, a second surface, a throughbore extending between the first surface and a second surface receiving the stem, and a tapered channel extending from the first surface toward the second surface. The tapered channel comprises a first width formed by the first surface and a second width that is greater than the first width for receiving a tool and facilitating placement.

### FIELD OF THE DISCLOSURE

The present disclosure generally relates to a fluid flow control device, and, more particularly, to a system for installing and removing a bellows nut from a fluid flow control device.

### BACKGROUND

In many types of fluid flow control devices and assemblies, extension components are used to position sensitive mechanisms at a safe distance from potentially damaging environments. For example, regulators and/or valves can use extension bonnets to move actuator components (e.g., an actuator casing) a safe distance from extreme temperatures, which oftentimes can be in excess of 450 degrees Fahrenheit. Typically, these extension bonnets can include sealing mechanisms such as a bellows to provide for enhanced sealing around a valve stem and other components.

A bellows nut is commonly used to secure the bellows in the extension bonnet. Generally speaking, to secure the bellows nut to the assembly, a significant amount of torque (e.g., approximately 250 lb.-ft. or more) is needed. To replace the bellows, as well as a number of components located inside or coupled to the valve, the bellows nut must first be removed from the valve assembly. Typically, the bellows nut has a rectangular slot that accepts a similarly-shaped mating part on a tool. When tightening the bellows nut using the tool, the torque required can cause the mating region between the bellows nut and the tool to quickly wear down and thus require frequent replacement of the bellows nut and/or the tool, oftentimes after a single installation and/or removal. For example, if the components are not precisely aligned, the edges of the nut and the tool can easily become deformed or rounded. In the event the components are not properly aligned, the tool can potentially slip and lead to injury. Further, multiple people are usually needed to properly maintain alignment in order to ensure the parts can be used on multiple occasions, thus resulting in reduced efficiency and greater operator costs and involvement.

### SUMMARY

In accordance with one or more aspects, systems and approaches for installing components in a fluid flow control device may address the need for a strong and effective device. These components can provide a secure connection to the valve assembly, and can also be safely and easily removed while reducing component wear and tear. Components in the system can be easily aligned, thus increasing their life expectancy and reducing the risk of injury. Further, the arrangement of components can cause the load to be applied at proper orientations to certify the nut is receiving proper loading. Additionally, a single individual can install and remove the components, thus increasing operator efficiencies and reducing operating costs associated with the assemblies.

In accordance with a first exemplary aspect, a fluid flow control device includes a valve body defining an inlet, an outlet, a throat disposed between the inlet and the outlet, and a bonnet opening, a control element having a valve plug and an elongated stem coupled to the valve plug, an extension bonnet coupled to the bonnet opening, a bellows disposed in the extension bonnet, and a bellows nut threaded onto the elongated stem to secure the bellows in the extension bonnet and form a seal around the elongated stem. The bellows nut includes a first surface, a second surface, a throughbore extending between the first surface and a second surface receiving the stem, and a tapered (e.g., dovetailed) channel extending from the first surface toward the second surface. The tapered channel includes a first width formed by the first surface and a second width that is greater than the first width for receiving a tool and facilitating placement.

In these forms, the tapered channel is defined by a first sidewall, a second sidewall, and a third surface which can define a lower surface. The third surface may be disposed between the first surface and the second surface. An angle formed between the third surface and the first sidewall is less than 90 degrees. Similarly, an angle formed between the third surface and the second sidewall is also less than 90 degrees. In some examples, the angle formed between the third surface and the first sidewall is equal to the angle formed between the third surface and the second sidewall. In other examples, the angle formed between the third surface and the first sidewall is different than the angle formed between the third surface and the second sidewall.

In some forms, a fastening system for a fluid flow control device includes a bellows nut adapted to thread onto an elongated stem to secure a bellows in an extension bonnet and a bellows nut tool adapted to remove the bellows nut from the fluid flow control device and secure the bellows nut to the fluid flow control device. The bellows nut can include a first surface, a second surface, a throughbore extending between the first surface and a second surface receiving the elongated stem, and a tapered channel extending from the first surface toward the second surface. The bellows nut tool includes an elongated stem and a head portion adapted to couple with the tapered channel.

In these forms, the bellows nut tool defines a bore extending through the elongated portion and the head portion. The bore is dimensioned to accommodate the elongated stem. The head portion includes a generally flat surface and a tapered protrusion extending from the generally flat surface. The tapered protrusion has a first width adjacent to the generally flat surface and a second width that is greater than the first width. In other words, the tapered protrusion is configured as a generally dovetailed protrusion. In these examples, the second width of the tapered protrusion is less than the first width of the tapered channel to allow the tapered protrusion to be inserted into the tapered channel.

### BRIEF DESCRIPTION OF THE DRAWINGS

The above needs are at least partially met through provision of the torque alignment nut and installation tool described in the following detailed description, particularly when studied in conjunction with the drawings, wherein:

FIG. 1 comprises a cross sectional front elevation view of an exemplary fluid flow control device using a dovetailed bellows nut in accordance with various embodiments of the invention;

FIG. 2 comprises a perspective view of the exemplary dovetailed bellows nut of the fluid flow control device of FIG. 1 in accordance with various embodiments of the invention;

FIG. 3 comprises a cross sectional perspective view of an exemplary bellows nut tool for installation and removal of the dovetailed bellows nut of FIGS. 1 and 2 in accordance with various embodiments of the invention;

FIG. 4 comprises a cross sectional front elevation view of the exemplary dovetailed bellows nut and the bellows nut tool of FIGS. 1-3 in accordance with various embodiments of the invention;

FIG. 5 comprises a cross sectional front elevation view of the exemplary dovetailed bellows nut and the bellows nut tool of FIGS. 1-4 in a mated configuration in accordance with various embodiments of the invention; and

FIG. 6 comprises a top plan view of the exemplary dovetailed bellows nut and the bellows nut tool of FIGS. 1-5, whereby the bellows nut tool engages the dovetailed bellows nut to apply a force thereto in accordance with various embodiments of the invention.

The figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

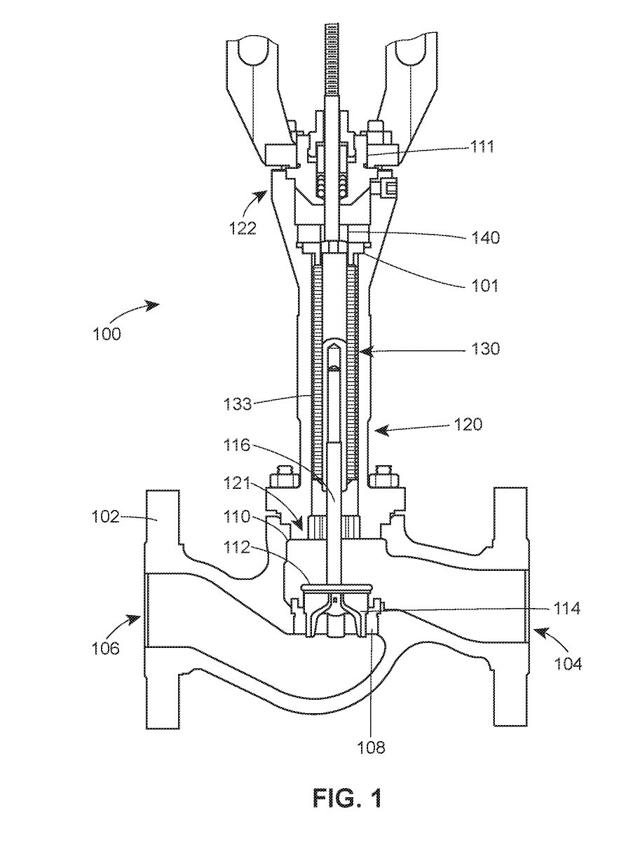

Generally speaking, the present disclosure relates to a fluid flow control device 100 (e.g., a valve or a regulator) for regulating the flow of a fluid. As illustrated in FIG. 1, the device 100 includes a valve body 102 defining an inlet 104, an outlet 106, a throat 108 disposed between the inlet 104 and the outlet 106, and a bonnet opening 110. The device 100 further includes a control element 112 disposed within the throat 108 of the valve body 102 and includes a valve plug 114 and an elongated stem 116 coupled to the valve plug 114. The device 100 also includes an extension bonnet 120, a bellows 130 disposed in the extension bonnet 120, and a bellows nut 140. The system 100 can include any number of additional components and/or subsystems (such as, for example, a trim assembly including a valve seat coupled to the valve body 102 at the throat 108, any number of gaskets, bushings, etc.) known to those having skill in the art and will not be described herein for the sake of brevity. An example of devices 100 may include the Fisher GX Control Valve and Actuator System which can be used in high-heat environments.

The control element 112 is adapted for displacement between a first position and a second position for controlling the flow of fluid through the valve body (e.g., from the inlet 104 to the outlet 106). The extension bonnet 120 is coupled to the bonnet opening 110 and defines a first end 121 disposed adjacent to the bonnet opening 110 and a second end 122. The extension bonnet 120 further defines a core 123 between the first end 121 and the second end 122 which at least partially encloses or surrounds the elongated stem 116. Further, the bellows 130 is disposed in the core 123 of the extension bonnet 120 to form a seal around the elongated stem 116.

The bellows nut 140 includes a first surface 141, a second surface 142, a throughbore 143 extending between the first surface 141 and the second surface 142 to receive the elongated stem 116, and a tapered channel or opening 144 extending from the first surface 141 toward the second surface 142. The bellows nut 140 is threaded onto the elongated stem 116 to secure the bellows 130 in the extension bonnet 120. In some examples, the device 100 can further include a bellows gasket 101 adapted to form a seal between the extension bonnet 120 and an upper bonnet 111. The upper bonnet 111 may also include an opening (not shown) dimensioned to receive at least a portion of the elongated stem 116.

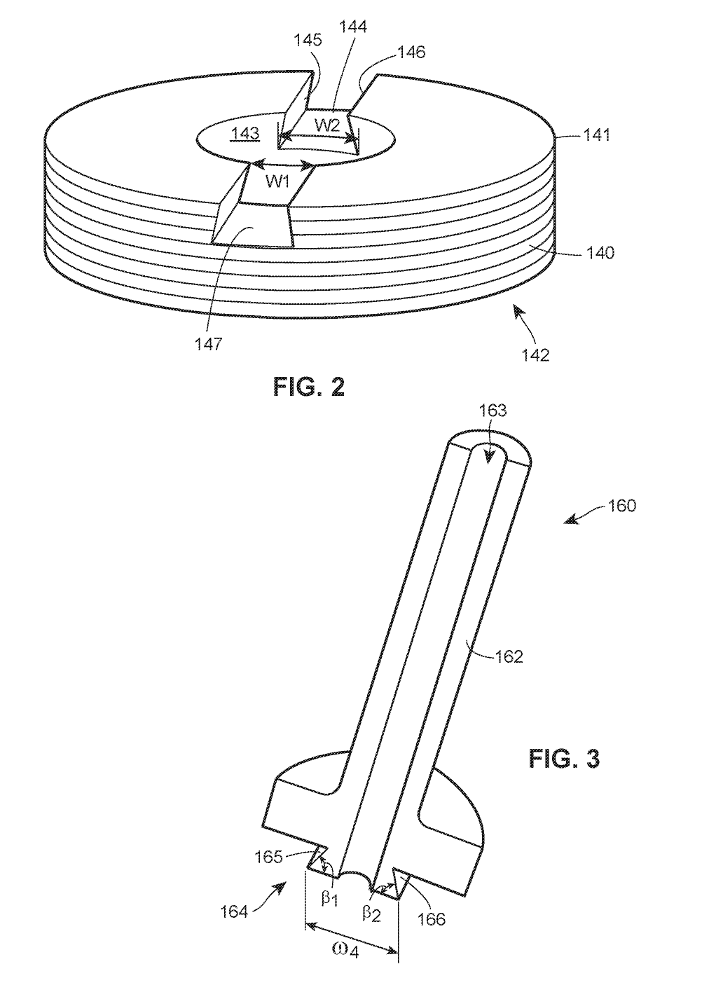

As seen in FIGS. 2, 4, and 5, the tapered channel 144 is defined by a first sidewall 145, a second sidewall 146, and a third surface 147 which is located between the first surface 141 and the second surface 142 that defines a lower limit or surface of the tapered channel 144. The tapered channel 144 has a first width W1 formed by the first surface 141 and the first and second sidewalls 145, 146 and further has a second width W2 formed by the third surface 147 and the first and second sidewalls 145, 146. The second width W2 is greater than the first width W1, thus the first sidewall 145 and the second sidewall 146 are angled relative to the third surface 147, thereby creating a dovetailed configuration. In other words, the first sidewall 145 and the second sidewall 146 converge from the third surface 147 towards the first surface 141, or conversely, the first sidewall 145 and the second sidewall 146 diverge from the first surface 141 towards the third surface 147.

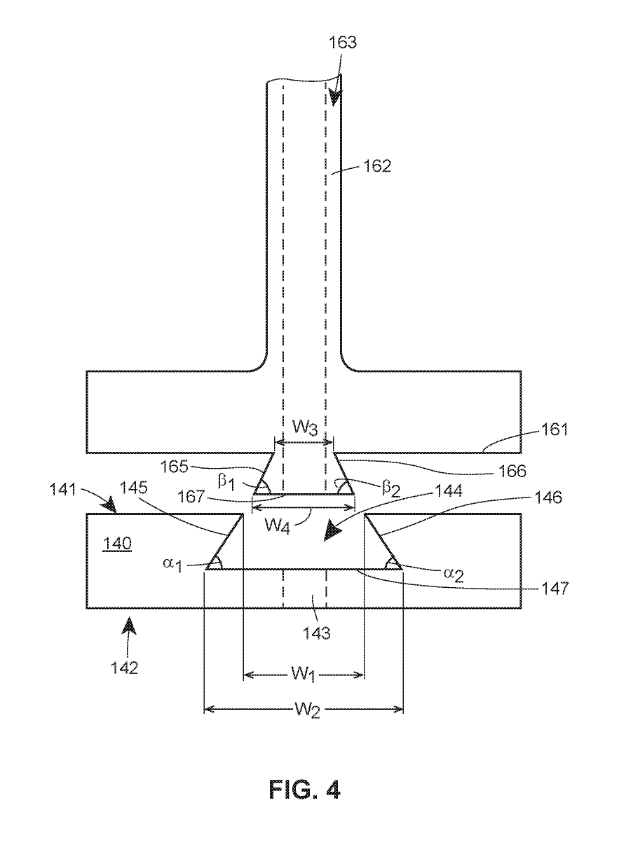

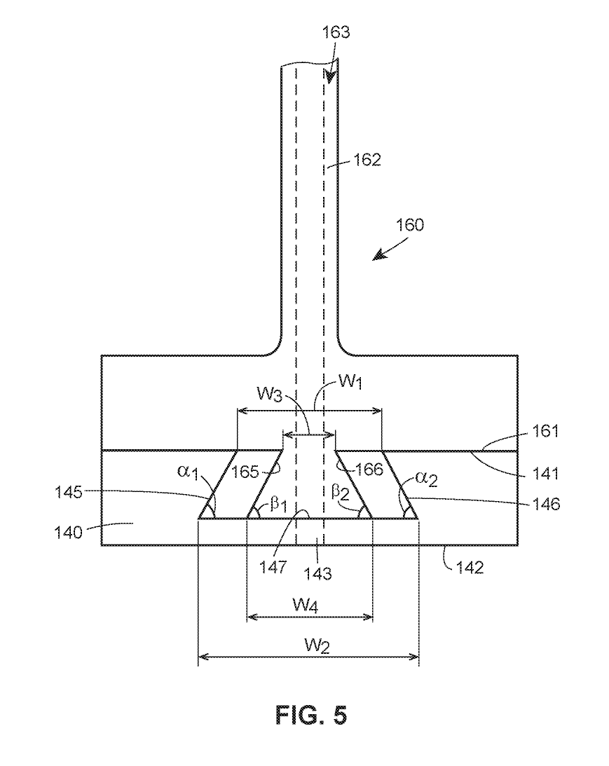

As illustrated in FIGS. 4 and 5, the first sidewall 145 and the third surface 147 form an angle α1. Similarly, the second sidewall 146 and the third surface 147 form an angle α2. The angles α1 and α2 are each less than 90 degrees. In some examples, the angles α1 and α2 are equal to each other, and in other examples, the angles α1 and α2 are different.

As illustrated in FIGS. 3-5, the device 100 further includes a bellows nut tool 160 to facilitate placement of the bellows nut 140. In other words, the bellows nut tool 160 is adapted to remove the bellows nut 140 from and/or secure the bellows nut 140 to the device 100. The bellows nut tool 160 includes an elongated portion 162, a head portion 164 which is adapted to couple with the tapered channel 144 of the bellows nut 140, and a throughbore 163 extending through the elongated portion 162 and the head portion 164. The throughbore 163 is dimensioned to accommodate the elongated stem 116. The bellows nut tool 160 may also include a gripping and/or attachment portion (not shown) disposed on the elongated portion 162 to assist securing and/or removing the bellows nut 140. For example, the gripping and/or attachment portion may include a protrusion, a wedge, or other similar component to be inserted into or otherwise coupled with a torque bar or rod to apply a desired torque. Other examples are possible.

In the described examples, the head portion 164 of the tool 160 includes a tapered protrusion extending from a generally flat surface 161. The tapered protrusion 164 is defined by a first sidewall 165, a second sidewall 166, and a third surface 167 which is located a distance away from the generally flat surface 161. The third surface 167 defines a lower limit of the tapered protrusion 164. The tapered protrusion 164 has a first width W3 defined by the intersection of the first surface 165 and the second surface 166 with the generally flat surface 161 and has a second width W4 defined by the length of the third surface 167. The second width W4 is greater than the first width W3, thus the first sidewall 165 and the second sidewall 166 are angled relative to the third surface 167, thereby creating a dovetailed configuration. In other words, the first sidewall 165 and the second sidewall 166 converge from the third surface 167 towards the generally flat surface 161, or conversely, the first sidewall 165 and the second sidewall 166 diverge from the generally flat surface 161 towards the third surface 167.

Additionally, the second width W4 of the tapered protrusion 164 is less than the first width W1 (and accordingly, the second width W2) of the tapered channel 144. The configuration of the tapered protrusion 164 forms a “male” component which is adapted to be inserted into the “female” configuration formed by the tapered channel 144.

The first sidewall 165 and the third surface 167 of the bellows nut tool 160 form an angle β1. Similarly, the second sidewall 166 and the third surface 167 form an angle β2. The angles β1 and β2 are each less than 90 degrees. In some examples, the angles β1 and β2 are equal to each other, and in other examples, the angles β1 and β2 are different. Further, any combination of the angles β1 and β2 may be equal and/or different to the angles α1 and α2 of the bellows nut 140.

Because the second width W4 of the tapered protrusion 164 is less than the first width W1 of the tapered channel 144, the bellows nut tool 160 can be inserted into the tapered channel 144 vertically. As a result, the tapered protrusion does not need to be inserted into the tapered groove in a manner typically required (i.e., by sliding the tapered protrusion laterally along the tapered groove or vise-versa), which, due to limited available space in the device 100, would be difficult if not impossible. Further, as illustrated in FIG. 5, because the bellows nut tool 160 has an appropriately-dimensioned throughbore 163, the bellows nut tool 160 can be inserted downwardly into the device 100 and over the elongated stem 116, and can be coupled to the bellows nut 140 without needing to remove the elongated stem 116. Additionally, the generally flat surface 161 of the bellows nut tool 160 is adapted to abut the first surface 141 of the bellows nut 141 and the third surface 147 of the bellows nut 140 is adapted to abut the third surface 167 of the bellows nut tool 160, thus providing a stable surface that reduces the likelihood of the nut removal tool sleeping or being misaligned. In some examples, any or all of these surfaces 141, 161, 147, 167 may include a gripping material and/or other alignment structures such as ridges, protrusions, tabs, notches, etc. to assist in alignment and/or stability of the bellows nut and the bellows nut tool 160 when coupled together.

The assembly (including the bellows nut 140 and the bellows 130) can be secured to the device 100 by first inserting the bellows 130 into the extension bonnet 120 so the bellows 130 at least partially surrounds the elongated stem 116. Next, the bellows nut 140 is inserted onto the elongated stem 116 adjacent to the bellows 130. In some examples, additional components (e.g., a bellows gasket) may be disposed between the bellows 130 and the bellows nut 140. The bellows nut tool 160 is then inserted onto the elongated stem 116 via the throughbore 163 and aligned with the bellows nut 140 to allow the tapered protrusion 164 to be mated with the tapered channel 144. The bellows nut tool 160 is then used to apply a torque (e.g., at least 250 lb.-ft.) to the bellows nut 140.

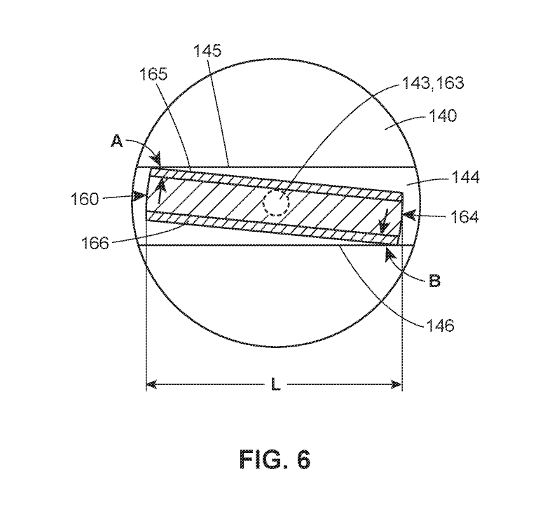

Upon using the bellows nut tool 160 to apply torque to the bellows nut 140, the tapered protrusion 164 twists inside of the tapered channel 144 due to its size being generally smaller than the tapered channel. As illustrated in FIG. 6, the twisting action causes the first surface 165 of the tapered protrusion 164 to contact the first surface 145 of the tapered channel 144 at a contact region A, and the second surface 166 of the tapered protrusion 164 to contact the second surface 146 of the tapered channel 144 at a contact region B. It is understood that if the bellows nut tool 160 is twisted in the opposite direction, the contact regions A, B will be on opposite lengths of the first and second surfaces. In either twisting direction, either one or both of the contact regions A, B are less than half of the overall length L of the tapered protrusion 164. In some examples, the contact regions A, B have a length extending from an outer edge of the tapered protrusion 164 to the throughbore 163. In other examples, the contact regions A, B have a length that is less than the length from an outer edge of the tapered protrusion 164 to the throughbore 163.

Because the tapered channel 144 and the tapered protrusion 164 are angled, when torque is applied to the bellows nut tool 160, the tapered protrusion 164 is effectively “locked” into the tapered channel 144 and cannot be removed. The first and second surfaces 145, 146 act as restrictive ledges in this torqued configuration, thus reducing the possibility of the bellows nut tool 160 from becoming misaligned relative to the bellows nut 140.

In the event the tapered channel 144 and/or the tapered protrusion 164 become deformed or worn, the surfaces of each the tapered channel 144 and the tapered protrusion can be machined to allow for continued use. Because the tapered protrusion 164 has angled first and second surfaces 165, 166, removing material from these surfaces 165, 166 during machining will not impact the points of contact between the tapered protrusion 164 and the tapered channel 144.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A fluid flow control device, comprising:
a valve body defining an inlet, an outlet, a throat disposed between the inlet and the outlet, and a bonnet opening;
a control element disposed within the throat of the valve body and adapted for displacement between a first position and a second position for controlling the flow of fluid through the valve body, the control element comprising a valve plug and an elongated stem coupled to the valve plug;
an extension bonnet coupled to the bonnet opening, the extension bonnet defining a first end disposed adjacent to the bonnet opening, a second end, and a core between the first end and the second end, the core adapted to at least partially enclose the elongated stem;
a bellows disposed in the extension bonnet, the bellows adapted to form a seal around the elongated stem; and
a bellows nut threaded onto the elongated stem to secure the bellows in the extension bonnet, the bellows nut comprising a first surface, a second surface, a throughbore extending between the first surface and the second surface receiving the elongated stem, and a tapered channel extending from the first surface toward the second surface;
wherein the tapered channel comprises a first width formed by the first surface of the bellows nut and a second width that is greater than the first width for receiving a tool and facilitating placement.

2. The fluid flow control device of claim 1, wherein the tapered channel is defined by a third surface, a first sidewall, and a second sidewall, wherein an angle formed between the third surface and the first sidewall is less than 90 degrees, wherein an angle formed between the third surface and the second sidewall is less than 90 degrees.

3. The fluid flow control device of claim 2, wherein the angle formed between the third surface and the first sidewall is equal to the angle formed between the third surface and the second sidewall.

4. The fluid flow control device of claim 2, wherein the angle formed between the third surface and the first sidewall is different than the angle formed between the third surface and the second sidewall.

5. The fluid flow control device of claim 2, wherein the third surface of the tapered channel is disposed between the first surface and the second surface, the third surface defining a lower surface of the tapered channel.

6. The fluid flow control device of claim 1, wherein the tapered channel comprises a dovetailed channel.

7. The fluid flow control device of claim 1, further comprising a trim assembly including a valve seat coupled to the valve body at the throat.

8. The fluid flow control device of claim 1, further comprising a bellows gasket adapted to form a seal between the extension bonnet and an upper bonnet.

9. The fluid flow control device of claim 1, wherein the upper bonnet comprises an opening dimensioned to receive the elongated stem.

10. A fastening system for a fluid flow control device, the fluid flow control device including a valve body defining an inlet, an outlet, a throat disposed between the inlet and the outlet, and a bonnet opening, a control element disposed within the throat of the valve body and adapted for displacement between a first position and a second position for controlling the flow of fluid through the valve body, the control element comprising a valve plug and an elongated stem coupled to the valve plug, an extension bonnet coupled to the bonnet opening, the extension bonnet defining a first end disposed adjacent to the bonnet opening, a second end, and a core between the first end and the second end, the core adapted to at least partially enclose the elongated stem, and a bellows disposed in the extension bonnet, the bellows adapted to form a seal around the elongated stem, the fastening system comprising:
a bellows nut adapted to thread onto the elongated stem to secure the bellows in the extension bonnet, the bellows nut comprising a first surface, a second surface, a throughbore extending between the first surface and a second surface receiving the elongated stem, and a tapered channel extending from the first surface toward the second surface; and
a bellows nut tool adapted to remove the bellows nut from the fluid flow control device and secure the bellows nut to the fluid flow control device, the bellows nut tool comprising an elongated portion and a head portion adapted to couple with the tapered channel.

11. The fastening system of claim 10, wherein the bellows nut tool defines a bore extending through the elongated portion and the head portion, wherein the bore is dimensioned to accommodate the elongated stem of the control element.

12. The fastening system of claim 10, wherein the head portion comprises a generally flat surface and a tapered protrusion extending from the generally flat surface.

13. The fastening system of claim 12, wherein the tapered protrusion comprises a first width adjacent to the generally flat surface and a second width that is greater than the first width.

14. The fastening system of claim 13, wherein the tapered channel comprises a first width formed by the first surface of the bellows nut and a second width that is greater than the first width for receiving a tool and facilitating placement.

15. The fastening system of claim 14, wherein the second width of the tapered protrusion is less than the first width of the tapered channel.

16. The fastening system of claim 10, wherein the tapered channel is defined by a first sidewall, and a second sidewall, and a third surface, wherein an angle formed between the third surface and the first sidewall is less than 90 degrees, wherein an angle formed between the third surface and the second sidewall is less than 90 degrees.

17. The fastening system of claim 10, wherein the tapered protrusion is defined by a first sidewall, and a second sidewall, and a third surface, wherein an angle formed between the third surface and the first sidewall is less than 90 degrees, wherein an angle formed between the third surface and the second sidewall is less than 90 degrees.

18. The fastening system of claim 10, wherein the bellows nut is adapted to withstand a torque of at least 250 lb.-ft.

19. A method of securing a bellows in a fluid flow control device having a valve body defining an inlet, an outlet, a throat disposed between the inlet and the outlet, and a bonnet opening, a control element disposed within the throat, the control element comprising a valve plug and an elongated stem coupled to the valve plug, an extension bonnet coupled to the bonnet opening and defining a first end disposed adjacent to the bonnet opening, a second end, and a core between the first end and the second end and being adapted to at least partially enclose the elongated stem, the method comprising:
providing a bellows nut adapted to thread onto the elongated stem, the bellows nut comprising a first surface, a second surface, a throughbore extending between the first surface and a second surface, and a tapered channel extending from the first surface toward the second surface;
inserting the bellows into the extension bonnet such that the bellows at least partially surrounds the elongated stem;
inserting the bellows nut onto the elongated stem adjacent to the bellows;
providing a bellows nut tool comprising an elongated portion and a head portion, the bellows nut tool defining a bore extending through the elongated portion and the head portion;
inserting the bellows nut tool onto the elongated stem such that at least a portion of the head portion is inserted in the tapered channel; and
using the bellows nut tool, applying a torque to the bellows nut.

20. The method of claim 19 wherein the head portion of the bellows nut tool comprises a generally flat surface and a tapered protrusion extending from the generally flat surface.

21. The method of claim 19, wherein the torque applied to the bellows nut is at least 250 lb.-ft.

22. The method of claim 19, further comprising machining at least one of a surface formed by the elongated channel and the head portion of the bellows nut tool.

23. The method of claim 19, wherein the bellows nut tool is inserted onto the elongated stem by at least partially inserting the elongated stem into the throughbore of the bellows nut tool.

24. The method of claim 19, wherein upon applying a torque to the bellows nut, less than half of a length of a first surface of the tapered protrusion contacts a first sidewall of the tapered channel, and less than half of a length of a second surface of the tapered protrusion opposite the first surface of the tapered protrusion contacts a second sidewall of the tapered channel.
